(19) United States
(12) Patent Application Publication
(10) Pub. No.: US 2025/0011992 A1
(43) Pub. Date: Jan. 9, 2025

(54) Full-Service Modular Autonomous Textile Sanitation, Washing, Drying, Transport, and Patron Transactional Processing System

(71) Applicants: Cheng Wei Ling, Orlando, FL (US); Robert Lucian Jimenez, Downingtown, PA (US)

(72) Inventors: Cheng Wei Ling, Orlando, FL (US); Robert Lucian Jimenez, Downingtown, PA (US)

(21) Appl. No.: 18/734,963

(22) Filed: Jun. 5, 2024

Related U.S. Application Data
(60) Provisional application No. 63/577,934, filed on Jun. 6, 2023.

(51) Int. Cl. D06F 25/00; B25J 9/16; D06F 23/02; D06F 34/05; D06F 34/18; D06F 34/26; D06F 37/06; D06F 37/22; D06F 37/30; D06F 39/02; D06F 39/08; D06F 39/14; D06F 103/04; D06F 103/18; D06F 103/32; D06F 103/34; D06F 105/48; D06F 105/58; D06F 105/62

(52) U.S. Cl. CPC D06F 25/00; B25J 9/1674; B25J 9/1679; D06F 23/02; D06F 34/05; D06F 34/18; D06F 34/26; D06F 37/06; D06F 37/22; D06F 37/304; D06F 39/022; D06F 39/085; D06F 39/087; D06F 39/088; D06F 39/14; D06F 2103/04; D06F 2103/18; D06F 2103/32; D06F 2103/34; D06F 2105/48; D06F 2105/58; D06F 2105/62

(57) ABSTRACT

The invention relates to a fully automated, energy-efficient garment washing system designed for use in commercial-base textile cleaning services, such as laundromats and wash and fold delivery services, etc. The system incorporates an AI-powered control unit that manages washing cycles, optimizes water and energy consumption, and provides patrons with monitoring and security options. The system features a robotic arm for automated loading and unloading of laundry using the easy clutch-able removable container, and multiple sensors for real-time monitoring and diagnostics. The washing main body also includes a futuristic design resembling an all-in-one 3D-printed unibody, emphasizing its advanced technology and eco-friendly operation. This system enhances user convenience, reduces operational costs, and promotes sustainable practices in the laundry industry.

### CROSS-REFERENCE TO RELATED APPLICATIONS

This application claims the benefit of prior-filed provisional application Ser. No. [63/577,934], filed on [Jun. 6, 2023], entitled [Full-Service Modular Autonomous Textile Sanitation, Washing, Drying, Transport, and Patron Transactional Processing System]).

### BACKGROUND OF THE INVENTION

### (1) Field of Invention

This invention is comprised of a series of devices in a centrally controlled computational process to automate the transport, cleaning, washing, sanitation, drying, dyeing, processing and service of textiles and garments or other articles of clothing to maintain their sanitation, appearance, freshness and aromatic cleanliness of the items in a private or commercial setting beyond the basic concept of washing and drying of textiles.

Therein all articles, items or things that can be or will be subject to benefit from the embodiments of the teachings in this application will be referred to as textiles, clothing, garments, or articles of clothing interchangeably for the purpose of explanation of the subsequent embodiments that involve this process including the devices listed but not limited to the invention as a whole or components contained therein.

This article of invention or embodiments enlists and implements multiple fully automated apparatuses and components such as actuators, mechanical motors, sensors, electromagnets, tubing, circuitry, computational boards, databases, and rotational devices, with the ability to articulate and move within any open space, in a modular system that requires no human intervention during the transport and/or processing of the textiles, clothing or garments to facilitate the steaming, sanitation, coloring, washing, and drying process of garments or articles of clothing beyond the initial textile input/drop-off or pick up by a customer, patron or attendant. The embodiments contained therein that culminate to encompass this system perform the entire process outside of human intervention. The only human intervention is during initial setup, periodic maintenance, and initial textile input. Existing washing, drying, and transport methods of textiles, garments, and/or articles of clothing require supervision by patrons visually in person or remotely via a “smart device”, portable computer, phone or standard computer to monitor their textiles and change machines during the process and move textiles to a drying extraction appliance once the wash cycle is finished to complete the wash/dry or Sanitation cycle. This involves patrons finding a facility or service, transporting the textiles to the location, finding a vacant machine, placing them in the machine, buying and adding detergent, choosing a wash cycle, depositing physical monetary coins, or using an existing transactional payment system (e.g. a physical payment card), etc. This wastes countless hours for the patron when otherwise the consumer could use this time for other means. Furthermore, other complications during this “traditional” method that could arise create countless obstacles for patrons, including but not limited to unmonitored machines, conflict with other patrons, mechanical failure, overloaded machines, safety, sanitation, theft of items, and cleanliness.

Traditional and already existing methods do not solve the fundamental problems plaguing the already existing process, wasted time, required monitoring by patrons or attendant staff, and facility safety concerns.

Existing methods are wasteful in a multitude of ways, including time, energy, resources, and efficiency. Additionally, these methods enlist and consist of non-modular systems that serve separate functions, and when they breakdown the entire machine is taken out of service until repaired, causing further disruption to the patron, and therefore causing further waste of time and resources that would otherwise be spent elsewhere for patrons or the host establishment. The physical space required for such existing methods is also wasteful and inefficient. When methods of existing establishments are used, it can also cause crowded venues and patrons to wait for available machines to serve their needs. Patrons leaving machines unattended and not removing textiles when finished is another common occurrence with existing methods.

Furthermore, the current invention pertains to the field of automated washing machines, specifically those designed with features that allow for remote operation and optimization of washing cycles. Recent developments in this field include various designs for removable laundry baskets. However, the invention at hand introduces a novel approach with a removable agitator combined with a lid that facilitates robotic handling, distinguishing it from existing removable basket designs.

### (2) Background Art

Several inventions have been developed that incorporate removable laundry baskets to enhance the convenience of loading and unloading laundry. These prior art references include:

US20070084254A1—Combination washer/dryer laundry basket: This invention involves a cylindrical mesh basket designed to fit within both the washer and dryer drums. The basket includes channels for receiving drum flanges, handles, and locking tabs to secure it during the washing and drying processes. The primary focus is on the ease of transferring laundry between the washer and dryer without handling individual items.

US20210277572A1—Washing machine with a removable basket: This design includes a supporting structure within the tank that secures the removable basket using arms and furrows. The basket is designed to be easily inserted and removed, providing a solution for simplified laundry handling and improved access to the machine's internal components for maintenance.

KR20010097200A—Washing machine with a detachable tub: This invention involves a detachable inner tub that can be used both for washing and as a laundry basket. The inner tub can be removed after washing is complete, allowing for easy transport of the laundry to a drying area.

Various Online References—Numerous online articles and product descriptions highlight washing machines with removable drums or baskets that serve as laundry baskets. These designs focus on user convenience by allowing the drum or basket to be easily removed and transported.

Novelty of the Current Invention—Unlike the prior art references that primarily focus on removable baskets, the current invention features a unique design with a removable agitator combined with a lid. This design enables a robotic arm to easily clutch and handle the agitator from the top side, enhancing automation and efficiency in laundry processing. The combination of a removable agitator and a lid not only simplifies the handling of laundry but also integrates seamlessly with advanced robotic systems, making the washing process fully automated and optimized for energy and water usage.

Usefulness—This invention significantly improves the efficiency and convenience of the laundry process—Enhanced Automation: The robotic-compatible lid allows for fully automated handling of laundry, reducing manual intervention. Optimized Washing: The agitator ensures thorough washing by improving the distribution of laundry and water, while its removable nature facilitates easy cleaning and maintenance. Energy and Water Efficiency: The system is designed to optimize resource usage, contributing to sustainability efforts.

Non-obviousness—The combination of a removable agitator with a lid for robotic handling is a non-obvious improvement over existing designs. Prior art focuses on removable baskets primarily for user convenience. The current invention goes a step further by integrating a solution that addresses the needs of automated systems and enhances the washing machine's overall functionality. This inventive step would not be obvious to someone skilled in the art, given the distinct advantages and novel features introduced.

Conclusion—The current invention offers a novel, useful, and non-obvious solution in the field of automated washing machines, distinguishing itself through the integration of a removable agitator with a lid designed for robotic handling. This innovation enhances automation, optimizes washing efficiency, and contributes to sustainability, providing significant improvements over existing technologies.

### SUMMARY OF THE INVENTION

The embodiments contained herein provide a solution that is a fundamental component of automating the textile, garment, and sanitation industries. This solution provides a method to automate the entire process of tracking, sanitation, cleaning, or dyeing any article of clothing and pairing it with a customer profile by means of the most integral object of this embodiment, the portable-interchangeable-modular ‘Agitating Canister’.

By grouping customer textiles, articles of clothing, or garments, with a central repository and that repository being paired to a customer profile, methods or ‘actions’ can then exist to inject this object (Agitating Canister) into a modular wash basin for processing and Sanitation in effect automating the entirety of the process for multiple loads of laundry without any physical customer interaction with the machines which in turn fosters an ultra-safe, efficient and effective environment for patrons (customer) and staff alike. Moreover, Patron (customer) can save their preference as a user profile in the system, so no need to select various options for the next use which saves more time.

This reaps multiple benefits, including environmental conservation by reducing waste and mistakes, limiting excessive use of water, and reduction of energy usage by already existing establishments utilizing older inefficient methods, which also require excessive water and energy. Furthermore, this embodiment fosters the reduction of crime and accidents by providing a safer environment that requires no patron or staff attending and waiting to the process as existing methods do.

### BRIEF DESCRIPTION OF THE DRAWING

For further comprehension of the embodiments of the invention as stated and designed where in this patent filing, reference is made to the following description taken in combination with the provided digitally illustrated figures:

FIG. 1 illustrates the core washing/drying system assembly in an exploded view, showing its key components. The locking main door (1) with an integrated seal (2) ensures secure closure of the system for water and air inside the system. The clutching mechanism for the robotic arm (3) facilitates automated interaction. A steel insert (4) reinforces the magnetic locking mechanism, while the canister locking cap (5) encloses the agitating canister (7), which has perforated holes (6) for water and airflow. The rotating repository barrel (8) agitates the contents and is secured by the clutch for the canister (9). The system's power is transmitted through the drive shaft (10), driven by the drive shaft motor assembly (13), all housed within the modular basin (11). The core drying assembly (12) completes the drying process using active air circulation.

FIG. 2A shows a front-angled view of the main washing/drying system. The system comprises the locking main door (1), which provides access to the interior of the modular basin (11). Above the wash basin is the core drying assembly (12), responsible for the drying process after washing. A drain valve/pump (17) is positioned at the base, facilitating the removal of wastewater post-wash.

FIG. 2B presents a rear-angled view of the main washing/drying system. The inner shelf (30) is situated within the modular basin (11) to support the placement of the agitating canister (7) during the wash cycle. The air intake pipe (20) and air turbine (22) are part of the drying assembly, ensuring efficient airflow. The drain pipe (16) connects to the drainage system for water removal.

FIG. 2C illustrates the top view of the main washing/drying system, focusing on the internal components. The drive shaft (10) connects to the agitating canister (7) via the turbine axle rod (18), enabling rotational movement during operation. The main door lock (31) is shown securing the locking main door (1) with an easy turn on the robotic arm to lock and seal, preventing accidental openings and water leaks during operation.

FIG. 2D provides a side view of the main washing/drying system. The modular basin (11) houses the agitating canister (7), which contains perforated holes (6) and the rotating repository barrel (8). The water intake valve/pump (14) and the multi-usage intake (15) dispense water, detergent, softener, and other fragrances into the washing cycle. The drive shaft bearing (32) supports the drive shaft, ensuring smooth rotation.

FIG. 2E depicts a side slice view of the main washing/drying system, revealing the internal structures. The locking main door (1), equipped with the integrated seal (2), ensures a watertight closure during operation. The drive shaft water seal (33) prevents water from leaking around the drive shaft (10). The agitating canister clutch lock (27) secures the canister to the drive mechanism. The washing and drying assembly joint (34) indicates the connection between the washing and drying components for seamless operation. The drain pipe (16) ensures efficient drainage of water post-wash.

FIG. 2F shows the front slice view of the main washing/drying system, focusing on the inner workings. The core drying assembly comprises the drying unit housing (19) and the air turbine (22), which is driven by the turbine axle rod (18) to circulate air for drying. The water intake valve/pump (14) and the multi-usage intake (15) facilitate the introduction of water and cleaning agents. The agitating canister (7), featuring agitating fins (24), is positioned within the modular basin (11) for optimal agitation. The drain channel (35) at the bottom ensures that water drains effectively during the cycle.

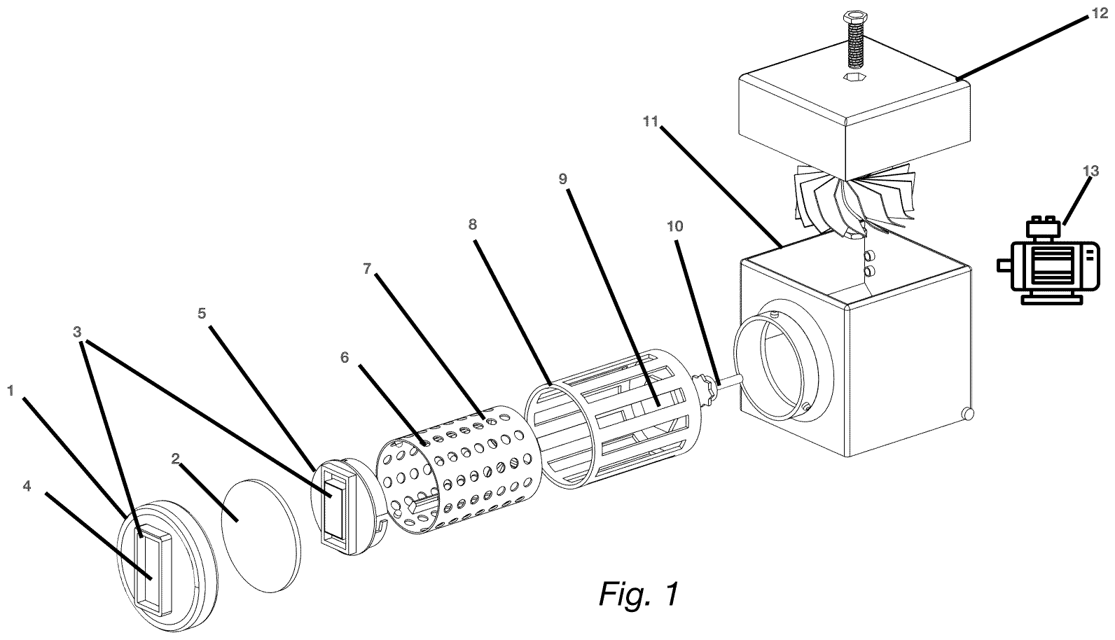

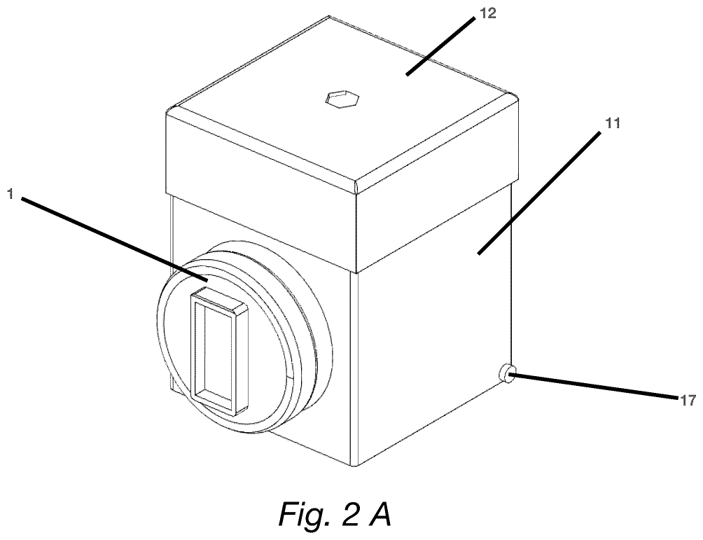

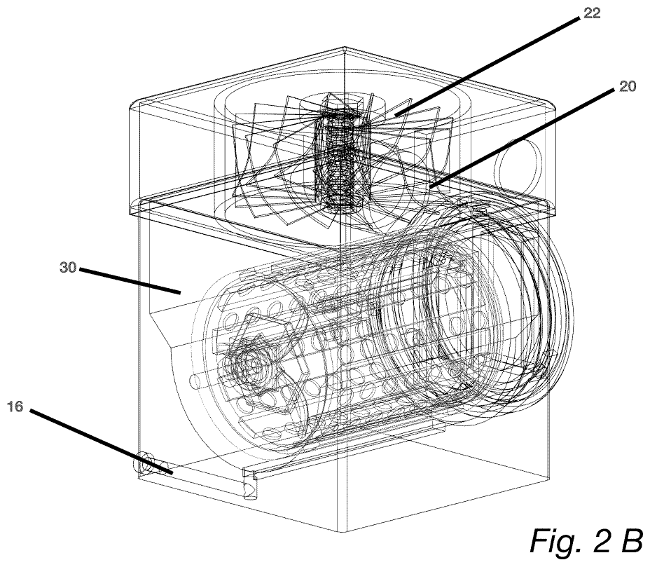

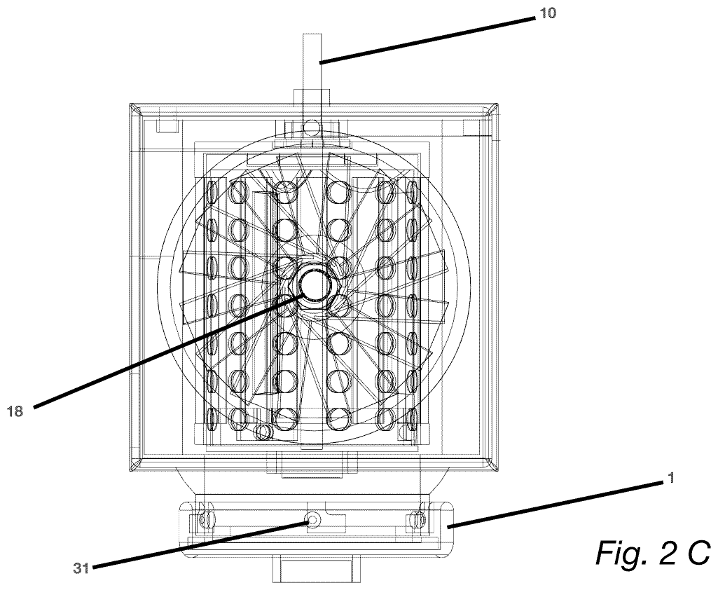

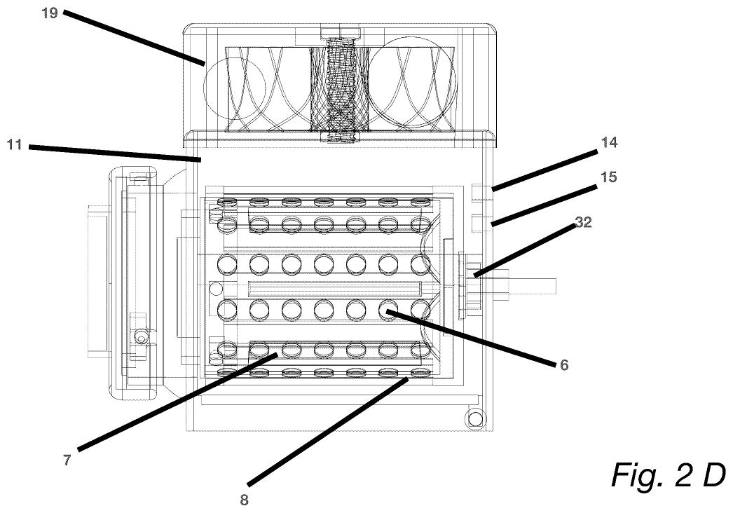

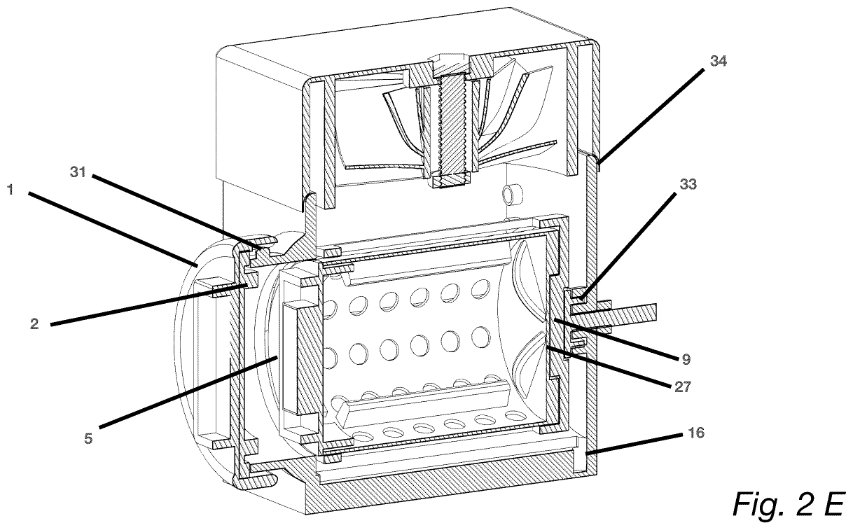

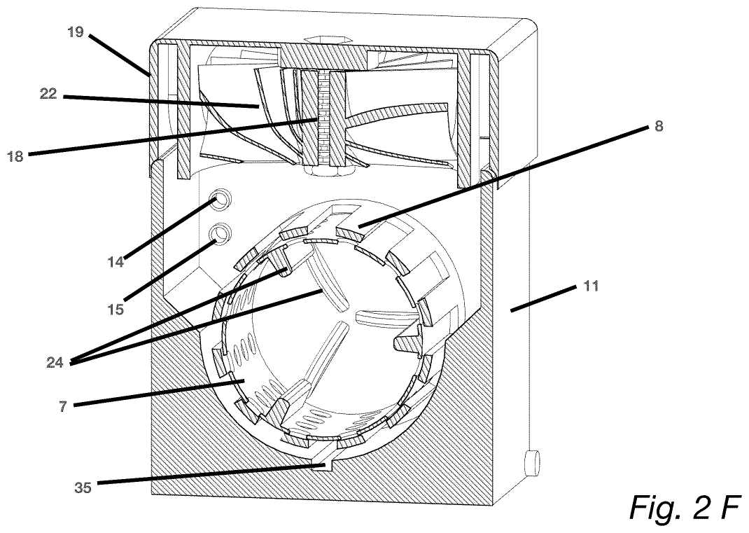

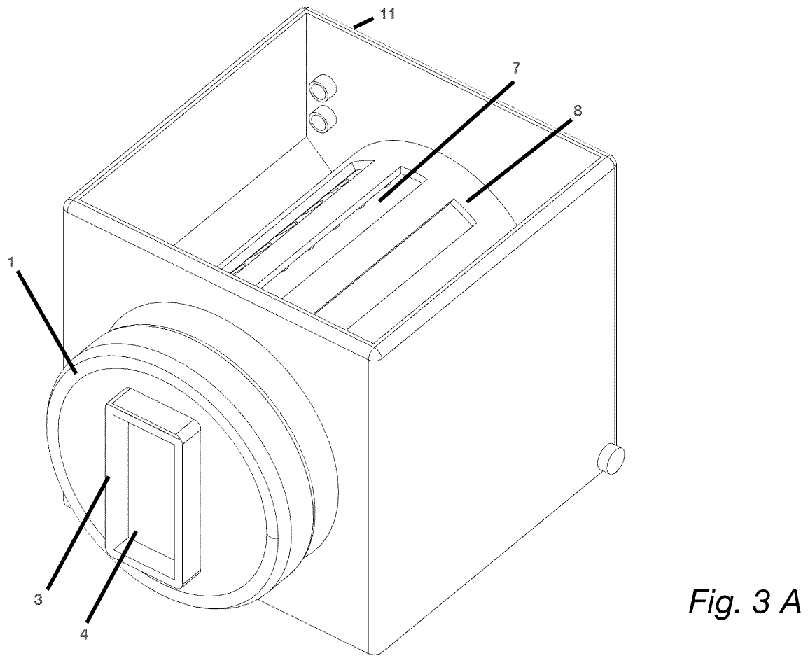

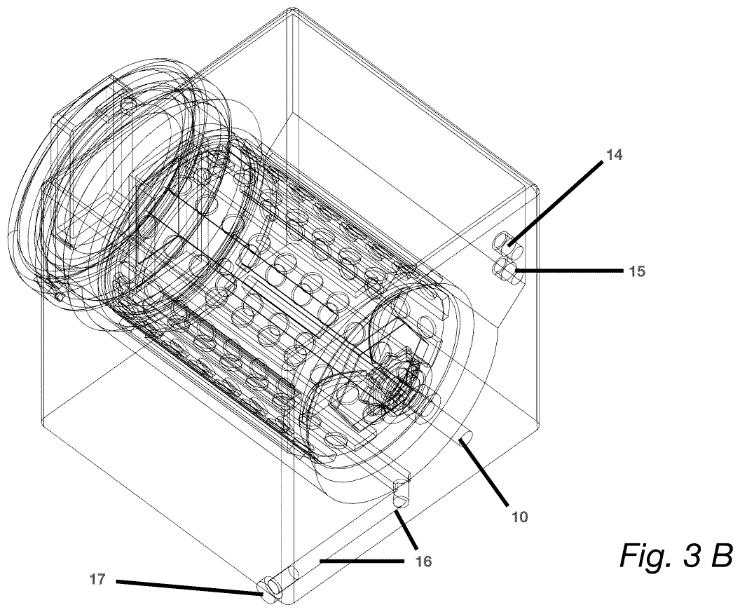

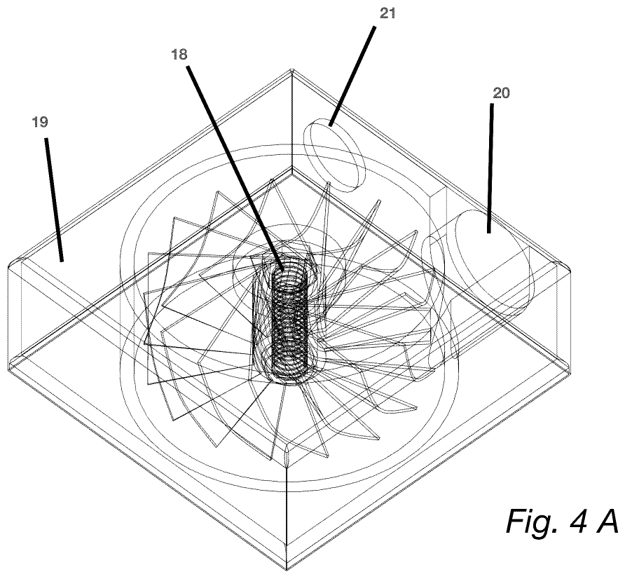

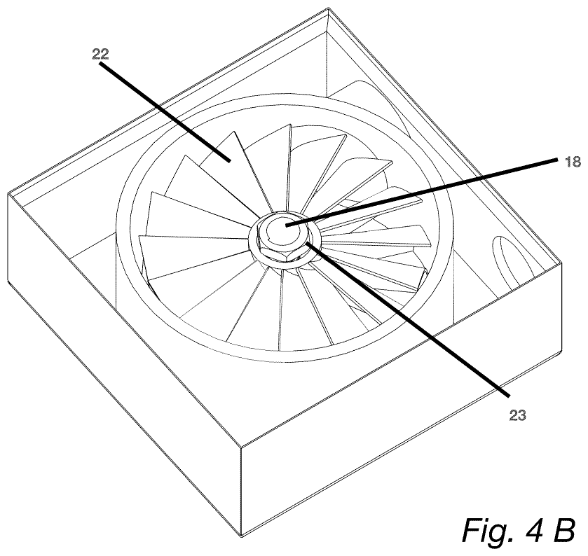

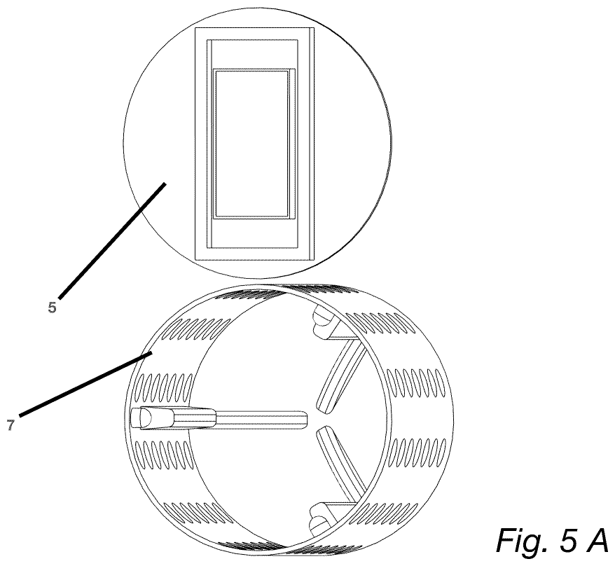

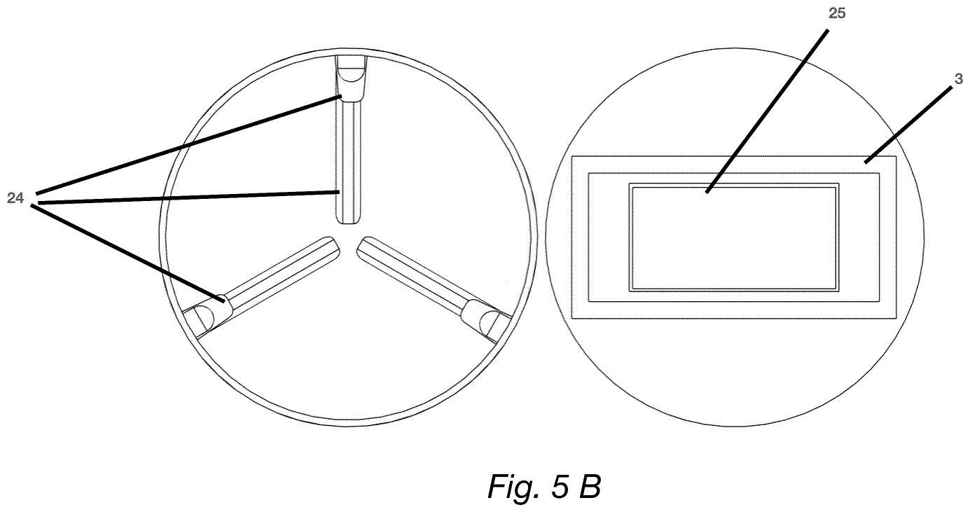

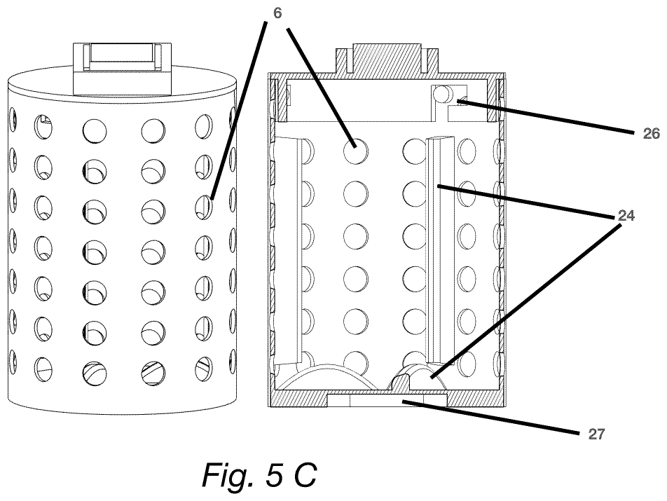

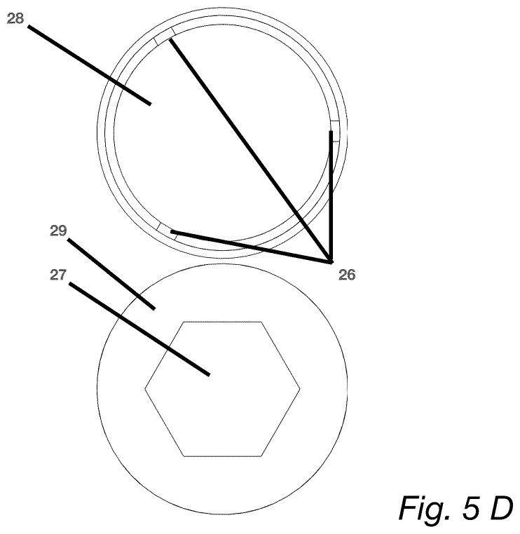

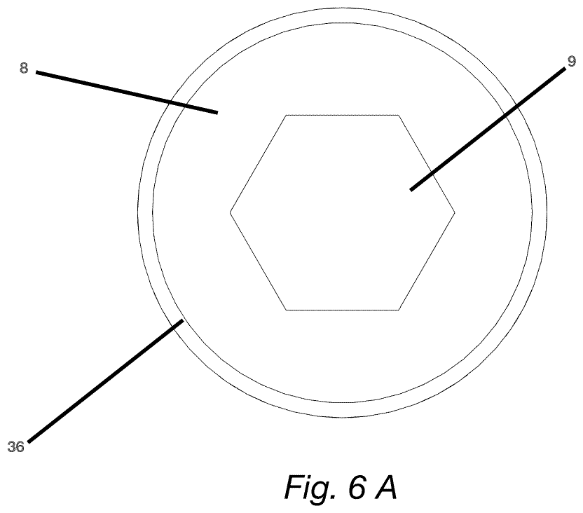

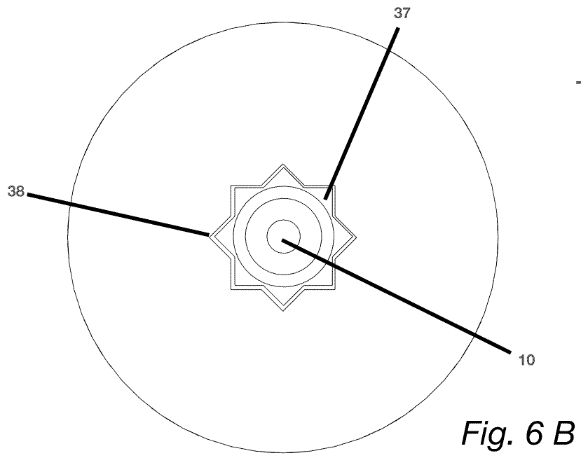

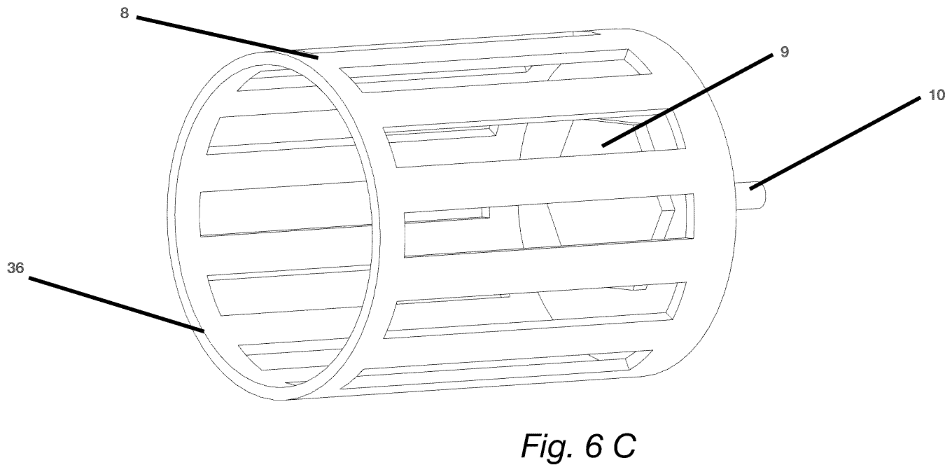

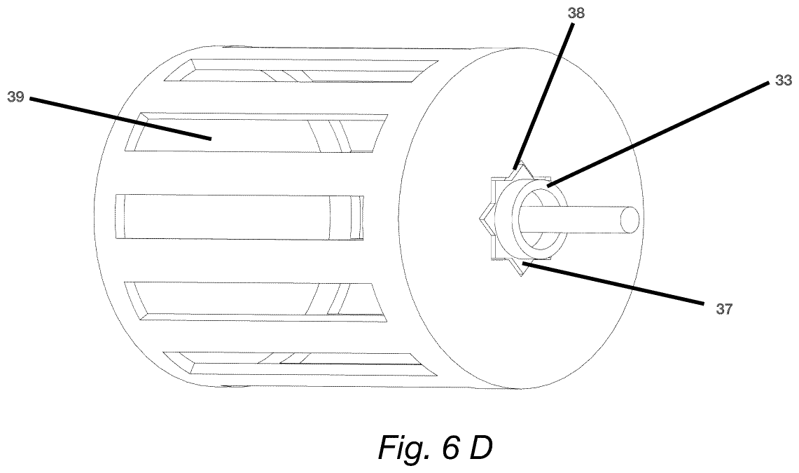

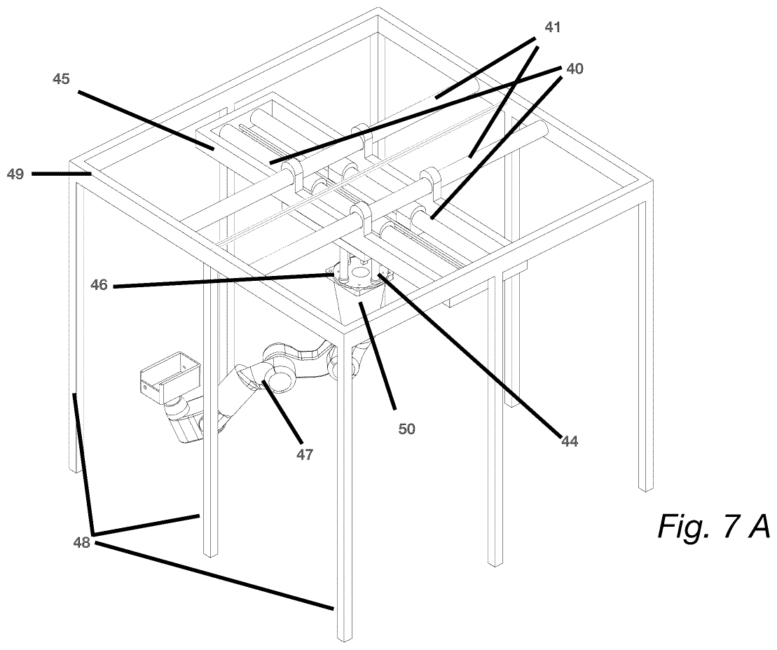

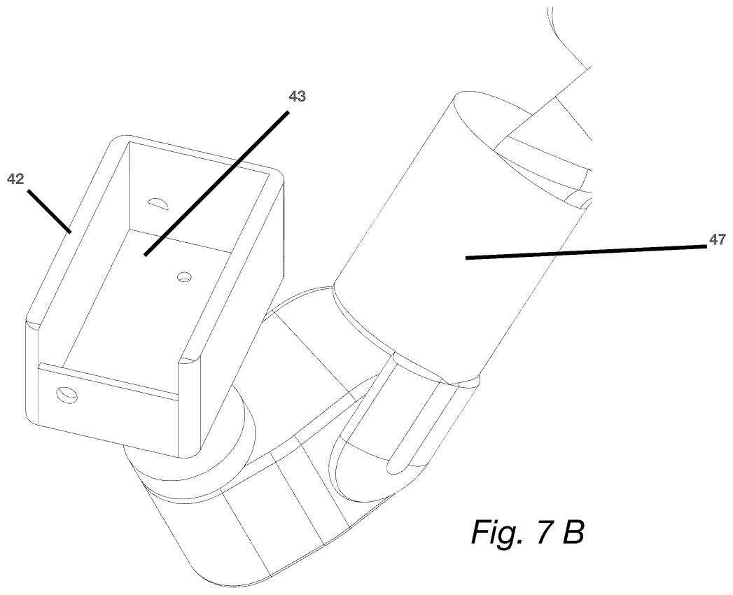

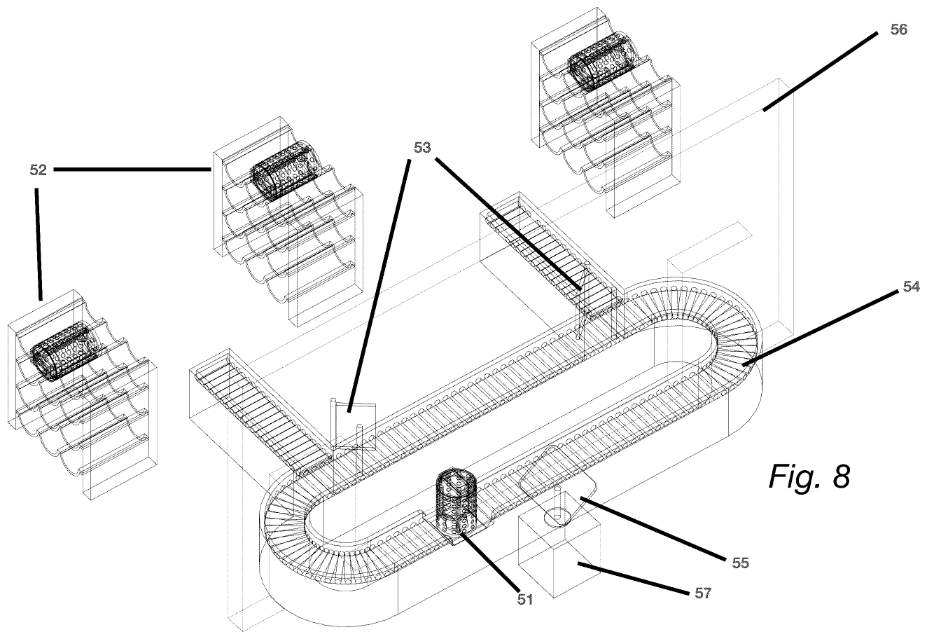

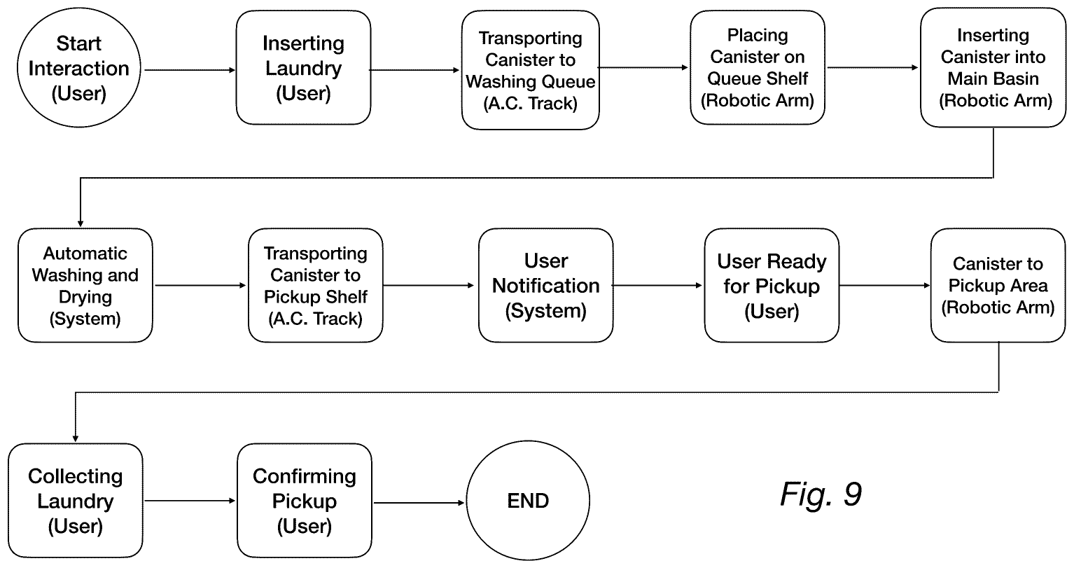

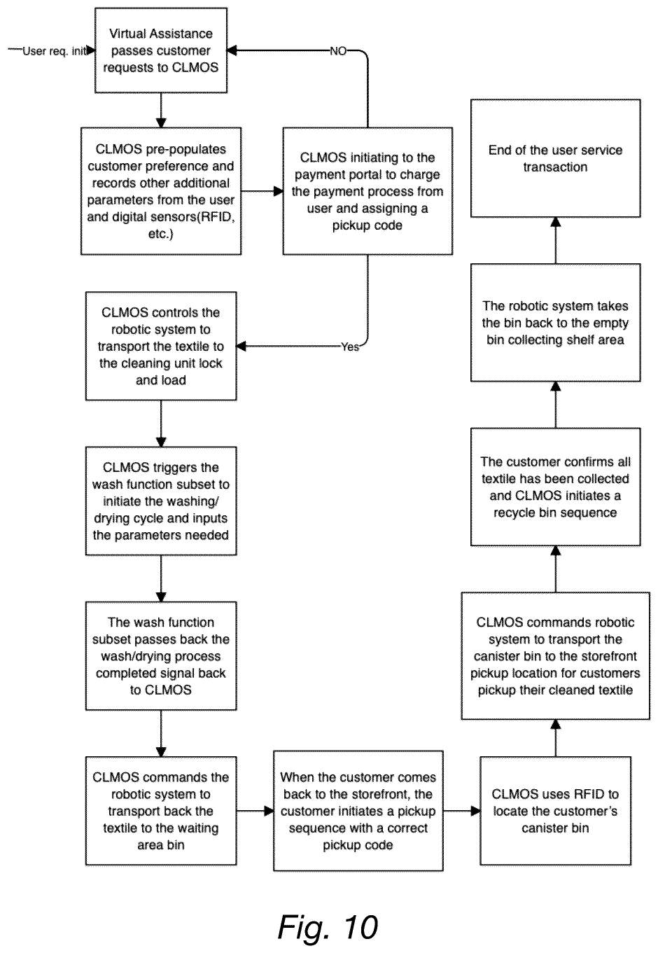

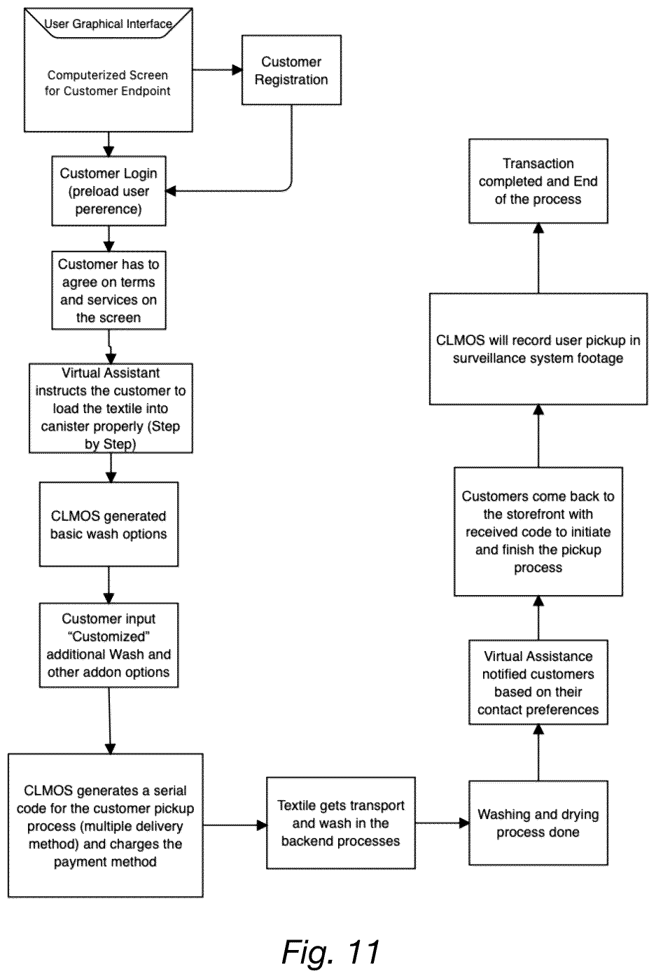

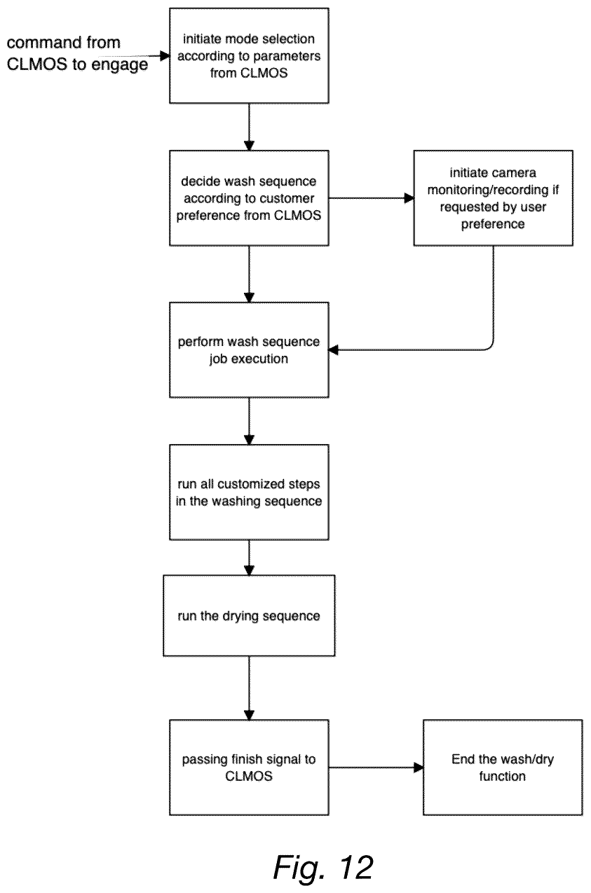

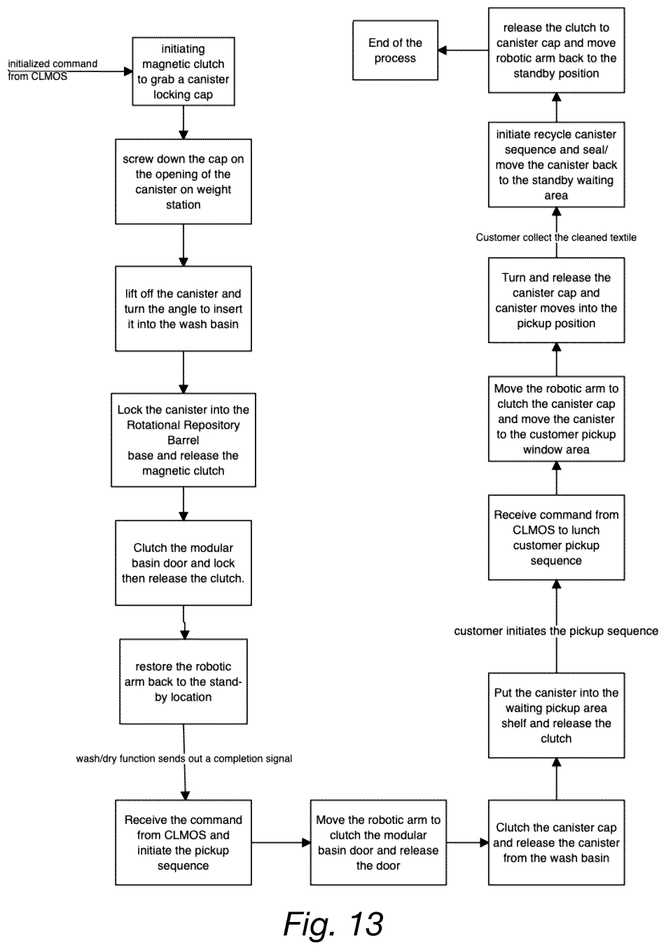

Referring to FIG. 3A, the front view of the core washing system highlights the key external and internal components. The locking main door (1) ensures secure closure of the washing chamber, aided by an integrated seal (2) to prevent water leakage. The clutching mechanism for the robotic arm (3) allows the system to automate the loading and unloading of the wash. A steel insert (4) reinforces the door structure for magnetic support during the arm-clutching operation. Inside the modular basin (11), the agitating canister (7) and rotating repository barrel (8) work together to efficiently agitate and rotate the laundry during the wash cycle.

In FIG. 3B, the back view presents the components that handle the intake and drainage of water and cleaning agents. The multi-usage intake (15) is designed to dispense detergent, softener, and other fragrances into the wash cycle, while the water intake valve/pump (14) supplies the necessary water. Wastewater is directed through the drain pipe (16), and managed by the drain valve/pump (17). The drive shaft (10) is connected to the rotating components, including the agitating canister (7) and the rotating repository barrel (8), driving their motion during both the washing and drying processes.

FIG. 4A presents a top view of the core drying system, illustrating key components responsible for air circulation and heat management. At the center of the system is the turbine axle rod (18), which drives the rotation of the air turbine. Surrounding this is the drying unit housing (19), which encases the main functional components. Air enters the system through the air intake pipe (20), allowing fresh air to flow into the system. After circulating, the air is exhausted through the air exhaust (21), ensuring that the drying process remains effective by removing moisture-laden air.

FIG. 4B offers a bottom view of the core drying system, focusing on the air turbine (22), which is driven by the turbine axle rod (18) to circulate air throughout the drying system. The turbine is secured in place by the turbine axle lock nut (23), which ensures that the turbine remains firmly attached during operation, maintaining stability and efficiency in air circulation.

FIG. 5A is an angled view of the agitating canister (7) and the canister locking cap (5). The canister locking cap (5) securely closes the agitating canister (7), allowing it to rotate without the risk of opening during operation. The agitating fins (24) are located on the sides and bottom of the agitating canister (7) to facilitate the agitation of clothes during the wash cycle, thereby enhancing cleaning efficiency. The perforated holes (6) are shown on the body of the agitating canister (7), allowing water and detergent to circulate freely through the interior, ensuring thorough washing and rinsing.

FIG. 5B shows the top view of the agitating canister (7) and the canister locking cap (5). The agitating fins (24) are positioned strategically inside the agitating canister (7) to maximize the agitation process, ensuring that clothes are evenly agitated and cleaned. The canister steel insert (25) is visible at the top of the canister, providing structural reinforcement. The clutching mechanism for the robotic arm (3) is also depicted, facilitating engagement with the robotic arm to rotate the canister efficiently during operation.

FIG. 5C illustrates a side view of the agitating canister (7) and the canister locking cap (5). The canister cap lock (26) is shown, indicating the locking mechanism that secures the canister locking cap (5) to the agitating canister (7). This locking mechanism ensures that the canister locking cap (5) remains securely fastened during the high-speed rotation of the agitating canister (7). The agitating fins (24) and perforated holes (6) are visible along the length of the agitating canister (7). The fins (24) extend along the sides and bottom to promote effective agitation of laundry, while the perforated holes (6) allow water, detergent, and air to pass through the canister, improving washing and drying performance.

FIG. 5D provides the bottom view of the agitating canister (7) and the canister locking cap (5). The bottom view canister cap (28) and bottom view agitating canister (29) offer a clear perspective of the base of the agitating canister (7), including the locking mechanism. The agitating canister clutch lock (27) is depicted, which connects the agitating canister (7) to the drive mechanism. This clutch lock (27) enables the agitating canister (7) to be securely fastened to the drive shaft, ensuring stable rotation. The canister steel insert (25) is also visible, enhancing the structural integrity of the agitating canister (7) to withstand the mechanical forces exerted during operation.

FIG. 6A illustrates the front/inside view of the rotational repository barrel (8) and the agitating canister clutch (9). The entrance of the agitating canister (36) is designed to allow the agitating canister (7) to be placed inside the repository barrel. The barrel (8) features the agitating canister clutch (9), which ensures that the agitating canister is securely fastened during the rotation. This clutch mechanism (9) allows the rotational repository barrel (8) to engage with the internal drive mechanism, promoting efficient rotation of the canister during washing and drying operations.

FIG. 6B shows the bottom view of the rotational repository barrel (8) and the drive shaft (10) assembly. The drive shaft clutch (37) and the drive shaft lock (38) are depicted, indicating how the rotational repository barrel (8) is connected to the drive shaft (10). The drive shaft clutch (37) secures the barrel to the drive shaft, ensuring synchronized rotation. The drive shaft lock (38) further strengthens this connection, preventing the barrel from detaching during operation. This arrangement ensures that the rotational repository barrel (8) can rotate in unison with the drive shaft, enhancing the washing and drying effectiveness with precision control capability.

FIG. 6C presents the front side view of the rotational repository barrel (8), emphasizing the agitating canister clutch (9) and the drive shaft (10). The side openings (39) along the barrel (8) facilitate the movement of water and detergent within the drum, ensuring uniform distribution during the wash cycle. The entrance of the agitating canister (36) is clearly shown, allowing access for inserting the agitating canister for the main laundry operation. This figure highlights the structural design that enables efficient agitation and movement of the contents inside the barrel.

FIG. 6D provides the rear side view of the rotational repository barrel (8) and drive shaft assembly. The drive shaft clutch (37) is engaged with the barrel, and the drive shaft lock (38) is securely fastened to maintain a fixed position. The drive shaft (10) extends through the barrel, enabling rotation and attachment to the motor assembly (13). The side openings (39) in the barrel facilitate fluid movement and airflow, improving the washing and drying processes. This view illustrates the precise integration of the drive shaft and rotational repository barrel, ensuring stable operation during high-speed cycles.

FIG. 7A illustrates the gantry with an articulating automated arm assembly. The assembly includes motorized X-Axis Guide Beams (40) and Y-Axis Guide Beams (41) that facilitate horizontal with X and Y directional arm movement, respectively. The Articulate Electromagnetic Clutch (42) engages and disengages with various components via the Electro-Magnet Insert (43), ensuring secure handling. Vertical movement is provided by the Motorized Telescoping/Adjustable Z-Axis Support (44). The X-Axis Support Frame Beams (45) and the Frame Ceiling Beam (49) maintain the structural stability of the gantry, while the Rotary Actuator (46) enables the arm's 360 degrees of rotational movement. The Automated Articulating Arm (47) is capable of precise handling tasks. The Support Beam Frame (48) and Hanger Mount (50) provide an essential structural foundation and support for handling objects.

FIG. 7B presents a closer view of the articulating automated arm's clutch mechanism, detailing the interaction between the electromagnetic clutch (42) and the arm's grasping components, specifically the Automated Articulating Arm (47) and the Electro-Magnet Insert (43), for secure and precise and effective operations.

FIG. 8 illustrates the Customer Staging Area (Store Front) designed for an automated laundry system. Central to this area is the Agitating Canister Track (54), which serves as the primary pathway for moving laundry canisters throughout the system. Positioned along this track is the Weigh Station (51), which provides a location for assessing the weight of the canisters, ensuring proper processing. The Motorized Traffic Gate (53) controls the flow of canisters, directing them to various stages of the operation. Surrounding the track are several Storage Shelves (52) where the canisters are temporarily placed during different phases of the laundering process. The Digital Computer Console (55), mounted on the Digital Computer Console Mount (57), provides the user interface and control center for the system, allowing customers and operators to monitor and manage operations. The entire staging area is enclosed by the Wall (56), which provides structural integrity and defines the operational boundary of the staging area. This setup ensures an efficient, automated handling process from the reception to the retrieval of laundry.

FIG. 9 illustrates the operational flow of the automated washing shop/facility, starting with user interaction. The user initiates the process by inserting laundry into the system. The laundry is then transported by the Agitating Canister Track (54) (A.C. Track) to the washing queue. A robotic arm places the canister on the queue shelf and subsequently inserts it into the main washing basin (11) for processing. The system autonomously carries out the washing and drying functions. Upon completion, the canister is transported to the pickup shelf via the A.C. Track. The system notifies the user, indicating readiness for pickup. The robotic arm moves the canister to the pickup area, where the user collects and confirms the laundry, concluding the automated service cycle.

FIG. 10 depicts the Central Laundry Management Operating System (CLMOS) software logistics for the automated laundry system. The process begins with a user request handled by the Virtual Assistant, which communicates with CLMOS. Upon validation, CLMOS collects customer preferences and sensor data, triggering the robotic system to transport the textile to the cleaning unit. Following the wash/dry cycle, a completion signal is sent to CLMOS, which uses RFID to locate the customer's canister. The system then guides the robotic arm to move the canister to the storefront for customer pickup, using a secure code. After pickup confirmation, CLMOS initiates a recycling sequence to return the empty canister to storage, completing the transaction.

FIG. 11 illustrates the Storefront/Customer App Process in the automated laundry system. The process initiates with customer registration via a user interface, where they log in and agree to the terms of service. The Virtual Assistant guides the customer through selecting wash options and loading textiles into the agitating canister. The system then generates a serial code for pickup and initiates the washing process. Once washing and drying are completed, the Virtual Assistant notifies the customer to return to the storefront for pickup. The customer retrieves their laundry using the provided code, and CLMOS records the transaction, concluding the process.

FIG. 12 depicts the Wash/Dry Software Program Function subset within the automated laundry system. The process starts with a command from CLMOS to initiate mode selection based on user-defined parameters. The system then determines the wash sequence according to customer preferences, initiating camera monitoring if required. It proceeds to execute the wash sequence, following all customized washing steps. The system then transitions into the drying sequence. Upon completion, a finish signal is sent to CLMOS, ending the wash/dry function.

FIG. 13 illustrates the Robotic Arm Software Program Function subset in the automated laundry system. The process begins with an initialized command from CLMOS to engage the magnetic clutch on the canister locking cap. The robotic arm lifts the canister, adjusts its angle, and inserts it into the wash basin. The canister is then locked into the Rotational Repository Barrel, followed by the release of the magnetic clutch. After completing the wash/dry cycle, the robotic arm receives a command from CLMOS to retrieve the canister, unlock it from the wash basin, and transfer it to the pickup area. The customer then collects the cleaned textiles, marking the end of the process.

### DETAILED DESCRIPTION OF THE INVENTION

The provided embodiments of this process in this filing seek to mitigate all the previously mentioned obstacles and considerations provided in the ‘Background of the invention’ and existing field and those unmentioned but obvious to further add efficiency and cleanliness, to make possible a streamlined, modular, and fully automated process that requires no physical interaction of the patron with the physical machines that will process their textiles, clothing, or other washable items.

The entire article on the invention and embodiments is centered around the modular, interchangeable agitating canister object (7) for the Modular Basin (11). This agitating canister and its subsequent design include a built-in agitator (24), a clutch (9) to engage the Modular Basin (11) during automated insertion via the Automated Articulating Arm (47) into the Rotational Repository Barrel (8), and perforated holes (6) to allow clean water from the water intake valve (14) or heated air to flow into the chamber from the ‘Core Drying System’ (12) and drainage of spent fluid (gray water) or cycled air. This component of the invention, the ‘Agitating Canister (7)’, facilitates agitation of the textiles during the wash and acts as a closed container to mitigate customer textile loss during travel and transport throughout the input and cleaning process. This object (Agitating Canister) will be referred to from here on in this filing interchangeably as the ‘Canister’ or ‘Agitating Canister’. The Canister will include RFID technology to facilitate tracking of customer textiles throughout the process via sensors and cameras. The canister is coupled or ‘paired’ with a user profile during the initial drop-off of textiles. This data is then communicated back to a database for logging, recording customer interaction, and systematic purposes via a remote, centrally controlled computational device, database, and software application.

Another object of the invention is the gantry object comprising a ‘support frame’ (FIG. 7A), which is modular. It should be noted that although a ‘Gantry’ or ‘Support Frame’ is described in the teachings of this filing or application, this object can be substituted with other modular systems, and in no way is this process limited to only gantry design. The term comprising does not limit or seek to negate or exclude other elements or steps. This filing seeks to provide the gantry design as a means of demonstration but is not limited to this substitution or example. This framing or gantry, for the purposes of this example in this application filing, facilitates the easy build-out of the embodiments into any size or dimensional space and acts as the middleware or frame of the device to facilitate the travel and/or transport of the canister from the storefront where a patron or facility attendant will input their textiles into the Canister. Then the Automated Articulating Arm apparatus (Robotic Arm) (47) will transport the Canister to the Modular Basin (11) opening via the transport framework as designed or demonstrated for the example in the embodiments of this application or filing. As previously stated, but to reiterate, this entire invention as a whole is not limited to gantry design but can include any mechanical apparatus shape or design to facilitate this step of the embodiments.

This step of the process consists of a robotic mechanical apparatus or ‘Automated Articulating Arm’ delivery system that includes a series of actuators, rotors, motors, and electromagnetic components to facilitate and articulate rotation, rotational movement, and multidimensional movement in any physical space where it exists. This device will hold or “grip” (42) the canister and/or “Cap” or “lid” (26) that is locked to the canister and allow the facilitation of movement or “transport” of the items or textiles (articles of clothing). If space does not permit, then the robotic arm delivery will be attached to an independent free-moving computer-controlled platform, base, frame, vehicle, or other apparatus to facilitate the canister and textiles delivery to the ‘Modular Basin (11).’

The canister is delivered via the ‘Automated Articulating Arm’ (47) attached to the gantry or computerized free-moving platform and with precision alignment, then inserted into the Modular Basin and subsequent Rotational Repository Barrel (8), aligned, and clutch engaged. The Modular Basin is then sealed by the Autonomous Articulating Arm with the Door (1) and closed/sealed to continue the process and engage the sanitation or cleaning or drying cycles.

Another object of the invention, the Modular Basin (11), includes a direct drive motor (13) for engaging rotation and/or centrifugal force to rotate the drive shaft and subsequent Rotational Repository Barrel that is engaged with the Agitating Canister clutch to accomplish the result of agitating the textiles during the cleaning process and drying (spinning) them at high speed during the extraction process using centrifugal force. The Modular Basin is modular in design and stackable. It consists of a half-barrel design that accommodates the Rotational Repository Barrel and the Agitating Canister objects.

The wash process (FIG. 9) is engaged via the smartphone app (FIG. 10) by the customer's account profile. Customization of wash, detergent selection, and fabric softener, as well as all wash preferences, are predetermined by the customer's application profile and their customized selections or pre-populated selections suggested by the system. To facilitate this process, the modular basin does include a multiple detergent dosing mechanism for various selections and accurate dosing of detergents and fabric softeners or dyes, a heating element, steam element, water level sensors, multiple water pumps, an optical imaging device (camera), RFID sensors, networked computational board, temperature sensors, and a sensor for balance as well as weight.

Once the app transaction is confirmed, users place their laundry into the agitating canister on a weight station (51). The canister is transported to a designated queue area via a transport track (Agitating Canister Track, 54). A robotic arm picks up the canister from the transport track and places it on a shelf labeled “Queue for washing.” When a washing machine becomes available, the robotic arm retrieves the canister from the shelf, inserts it horizontally into the modular basin, and clutches it with the agitating canister clutch (9) and agitating canister clutch lock (27). The washing process, which is controlled remotely through a central computer, automatically selects the appropriate washing cycle based on the laundry type along with the user profile and then proceeds to wash and dry the clothes.

Once the wash and dry cycle (FIG. 12) is complete, the canister is removed from the modular basin via the articulating automated arm or ‘robotic arm’ (47). The patron (Customer) is notified via an app or any other contact preference in the profile, and the robotic arm is engaged by the Central Laundry Management Operating System (CLMOS) (FIG. 10) to remove or eject the canister from the Modular Basin (11). The customer alerts the CLMOS via the application or other customer input method and/or device as described in this filing and subsequent customer profile that they have arrived at the storefront, or software methods and processes will be provided to also alert the CLMOS by means of customer-location-based approximation that the customer is near to or has arrived at the facility so that delivery can commence upon patron/customer or attendant arrival. The canister with its textiles is delivered to the storefront via a transport track (Agitating Canister Track, 54) where they can be removed by the patron (customer) and finish/complete the entirety of the process.

1: Interchangeable Modular Removable Agitating Canister Washing Drum
1. An interchangeable modular removable agitating canister washing drum, comprising:
A housing:
Having a generally cylindrical shape but configurable to be of various shapes;
Defining an open top adapted for closing or sealing with a lock lid and/or clutch;
Having a closed bottom;
Comprising perforated holes and/or perforated lines enabling free flow of liquid or air in or out during agitation washing and/or processing.
An attachment mechanism:
Adapted for insertion and removal from a companion washing appliance main body;
Including a mechanical clutch for engaging with the companion washing appliance's main body, allowing for secure attachment and detachment.
A drive mechanism:
An attached or built-in mechanical clutch that can engage with the companion washing appliance's main body, allowing for manipulation of the housing in both horizontal and vertical positions;
Including a drive shaft connection point for transmitting rotational force from the washing appliance to the canister.
An access port:
The open top configured for insertion of textiles and/or garment items;
Including a funnel or guide structure to facilitate easy loading of items into the canister.
A closure mechanism:
The lock lid or clutch configured to contain any items inserted within the housing;
Incorporating a seal to prevent leakage of liquids during the washing process;
Featuring a locking mechanism to secure the lid during operation.
Agitating fins:
Positioned inside the canister to enhance the agitation of textiles during the wash cycle;
Designed to create turbulence and improve washing efficiency.

2: Modular Washing Appliance Main Body with Interchangeable Agitating Barrel/Drum
2. A modular washing appliance main body compatible with interchangeable agitating barrels/drums, comprising:
A housing:
Having a generally box-shaped configuration but configurable to be oval, round, or rectangular;
Defining an open top or open front adapted for sealing or closing with a lid or door;
Having a hollow central interior configured to receive an interchangeable canister drum or barrel;
Constructed to be injection molded, printed, built, or formed as a unibody structure.
An attachment mechanism:
A built-in or attached clutching mechanism adapted to engage with an interchangeable canister drum or barrel;
Including alignment guides to ensure proper positioning and secure engagement of the canister.
A drive system:
Comprising a motor connected to a drive shaft for transmitting the rotational force to the canister drum;
Featuring speed and torque control to adjust the washing intensity based on the load.
A water intake system:
Including one or more water intake valves or pumps to supply water to the interior of the housing;
Equipped with a multi-usage port for the addition of laundry detergent, fabric softener, or other liquid applications.
A drainage system:
Featuring a drain pipe and valve or pump for removing water from the housing after the washing cycle;
Designed to efficiently expel water while preventing leaks.
An air circulation system:
Incorporating an air intake pipe, air turbine, and air exhaust for drying textiles after the washing cycle;
Equipped with sensors to monitor air temperature and humidity for optimized drying.
A control system:
Including a programmable central microcontroller for managing washing and drying cycles;
Integrated with sensors to monitor load, water levels, and other parameters;
Featuring a user interface for selecting and customizing wash cycles.
A safety system:
Including mechanisms to prevent the door or lid from opening during operation;
Featuring automatic shut-off capabilities in case of detected malfunctions or safety breaches.
A sensor system:
Integrated within the appliance main body to monitor the load and condition of the textiles;
Capable of communicating with the main control unit of the washing appliance for optimized washing cycles.
Communication interfaces:
Providing connectivity with user devices for remote monitoring and control;
Capable of receiving updates and maintenance diagnostics from the manufacturer or service provider.

3: Automated Articulating Arm for Handling Agitating Canister
3. An automated articulating arm for a washing system, comprising:
A robotic arm with multiple degrees of freedom:
Including joints and actuators enabling movement in various directions and planes;
Configured to extend, retract, rotate, and pivot for precise positioning.
Actuators and motors:
Providing the necessary force and control for the arm's movements;
Featuring variable speed and torque settings for different tasks.
An electromagnetic clutch:
Engaging and manipulating the agitating canister securely;
Allowing for quick attachment and release of the canister.
Sensors:
Integrated to detect the position and orientation of the canister;
Communicating with the washing system's control unit for coordinated operations.
A control system:
Coordinating the arm's movements with the washing cycle;
Featuring programming capabilities for different movement sequences and tasks.
Safety mechanisms:
Including collision detection to prevent damage to the arm and surrounding equipment;
Featuring emergency stop functions to halt operations in case of malfunctions.
